(19) United States
(12) Patent Application Publication
(10) Pub. No.: US 2007/0289218 A1
(43) Pub. Date: Dec. 20, 2007

(54) Pulley Device for Raising Vehicle Windows

(76) Inventor: Melchor Daumal Castellon, Barcelona (ES)

Correspondence Address: BLANK ROME LLP, 600 NEW HAMPSHIRE AVENUE, N.W., WASHINGTON, DC, 20037, US

(21) Appl. No.: 10/571,609

(22) PCT Filed: Feb. 9, 2005
(86) PCT No.: PCT/ES05/00062

§ 371 Date: Mar. 10, 2006

(30) Foreign Application Priority Data
Jun. 8, 2004 (ES) U200401377

(51) Int. Cl. E05F 11/48

(52) U.S. Cl. 49/352

(57) ABSTRACT

A device that includes a revolving pulley around which an operating cable is rolled which runs inside a cover and a support device onto which the aforementioned pulley is rigidly mounted on the end of the rail, and equipped with stoppers at the end of the cover. It includes a flat cover with an opening for the assembly of the stoppers which include a tubular body fixed to the flat, insides which the end of the cover is held. The tubular body has a lower extension to be inserted into the opening of the flat cover which is in a V shape to prevent the tubular body from being released from the flat cover once it is inserted into the opening.

The invention is for manually or automatically raising windows, basically consisting of at least one rail the length of which runs a slider, which is fixed by using a clamp to the lower end of the vehicle's window glass. The slider is moved by an operating cable. The rail has a pulley directly located at each end with a cable rolled around to create the up-and-down movement of the glass in the vehicle's window.

The pulley device into this proposed invention has a window lifter on the ends of the rail and because of its new configuration, which shall be described below in accordance with the invention, it considerably simplifies the configuration of the window lifter which up until now has been manufactured, thereby reducing the costs of the equipment.

Normally, the window lifting rail comprises a metal plate the ends of which are specifically configured to carry out several functions. More specifically, the ends of the conventional window lifters include a stopper on the slider run, a projection to prevent the cable escaping from the pulley, means of fixing the pulley and a support projection at the end of the cable cover.

The aforementioned configuration of the window lifter rail ends are mechanically bent double (to form a rail end a stopper, the projection to prevent the cable coming out of the pulley and the support projection at the end of the cable cover). Inserting the ends form the means of anchoring the roller. Another conventional way of implementing the aforementioned configuration for the window lifter rail ends is to weld a piece on to the ends to include all other described parts so that they can carry out their corresponding functions.

Rails for window lifters in cars described in accordance with the aforementioned technique have several drawbacks. In the first place, forming the ends of the rails mechanically or joining additional pieces is costly, which negatively influences the final cost of the window lifters. Moreover, each rail end must properly fit into the door assembly of the vehicle, for example the direction of the operating cable cover opening may vary depending on the geometry of the door and the design of the window lifter.

The invention proposes one way of considerably reducing the cost of window lifters for vehicles and at the same time, standardising their assembly in such a way that by manufacturing the same type of rails and without ends which are formed in a particular way, they may be assembled in any type of vehicle door with a very high degree of accuracy.

In order to do this, a device is proposed which is formed by a revolving pulley around which an operating cable is passed which runs inside a cover; and a support device onto which this pulley is mounted and which is rigidly attached to the end of the window lifter rail. This support device, which may have a symmetrical shape, has stoppers at the end of the aforementioned cable cover and a means of positioning these stoppers at an angle so that they can be placed in different configurations, as shall be detailed.

The support device is a flat cover with at least one opening for assembling the aforementioned stoppers at the end of the aforementioned cable cover. Preferably, these stoppers include a tubular body fixed onto the aforementioned flat cover inside which the end of the cover is held. The tubular body has a lower extension which perpendicularly extends downwards to the surface of the flat cover which is inserted into the opening of the same. Also, the tubular body has a cross-section which is mainly V shaped to prevent the aforementioned body being released from the cover once it is inserted. It also has side tabs which are supported on the flat cover once the aforementioned lower extension is inserted into the same.

It is envisaged that the support device in the form of a cover has a positioning projection which extends downwards to be inserted into one of the holes in the rail. This projection may be easily and economically made by folding a part of the end of the flat cover.

The support device may include a central turret with a hole through it to fix the window lifter rail using the pulley. This hole it may be threaded or smooth.

In this configuration, the support device in the form of a flat cover fixes the pulley and supports the end of the cable cover. The positioning of the support device on the window lifter rail is easy to change and may be used for all types of window lifters.

As has been stated above, the pulley support device on the end of the rail has a symmetrical shape. This allows the piece to be used on the upper or lower part of the rail.

Therefore a highly versatile and standardised device is obtained, because it is totally independent of the rail; as opposed to previous technique where the configuration of the end was carried out during the rail's manufacturing process. This allows costs to be reduced, because the die cutting process for the rail is more economical.

The features and advantages of the device in this invention shall be clearer from the detailed description of the preferred layout of it which shall be given below, as a non-limiting example, with reference to the drawings attached, in which:

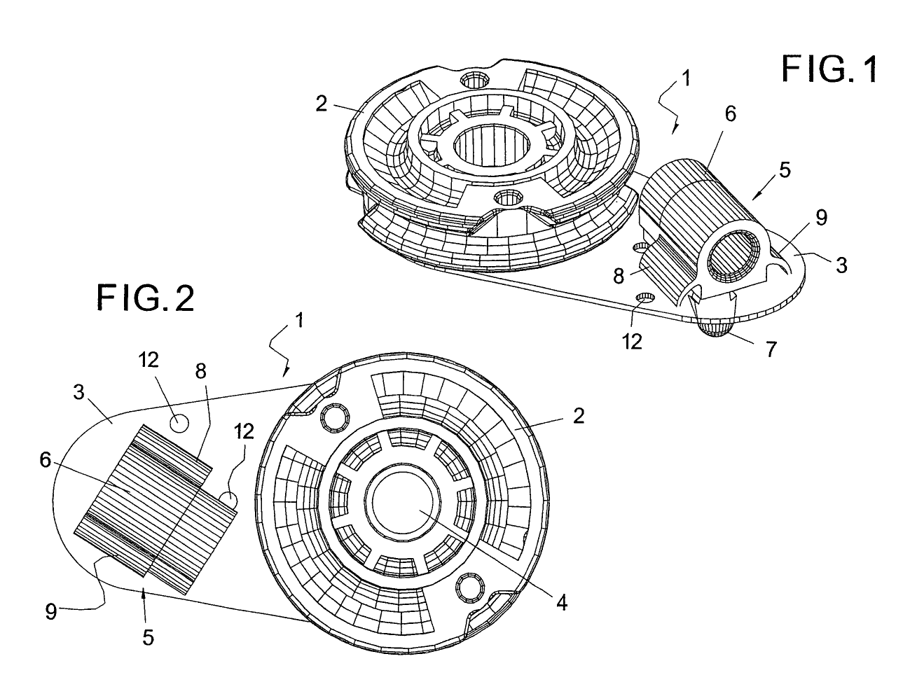

FIG. 1 is an overall view of the pulley device for window lifters in vehicles in accordance with the invention;

FIG. 2 is aerial view of the pulley device for window lifters from FIG. 1;

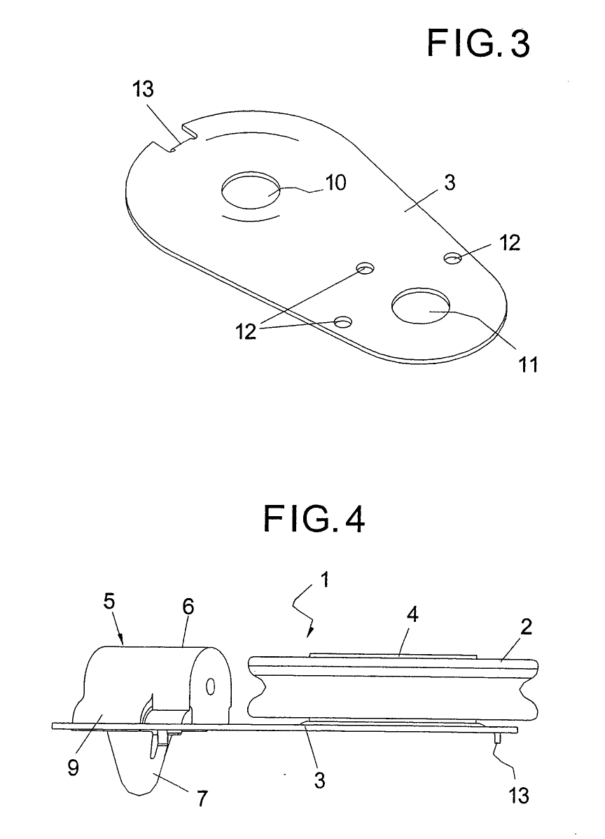

FIG. 3 is an overall view of the support device in the form of a flat cover; and

FIG. 4 is a side view of the device in FIG. 1.

The preferred layout described here in a non-limiting way in accordance with the invention is for a pulley device for window lifters in vehicles which has been given the overall number of (1) in FIGS. 1 and 2.

The device (1) illustrated includes a rotating pulley (2) around which the operating cable is passed (not shown) for the window glass which runs through the inside of the cover. The pulley (1) rotates on a support device (3) using a rivet (4). As may be seen, this die cut support device (3) has a rectangular opening (11), or as shown in FIG. 3 a circular opening, for attaching a stopper (5) at the end of the aforementioned cable cover. These stoppers (5) at the end of the cable cover may be positioned at a variable angle as shall be described below.

The aforementioned rivet (4) goes through the pulley (2), the support device (3) via a hole (10) as shown in FIG. 3. It also passes through the rail (not shown). The support device (3) is rigidly attached to the aforementioned rail and is symmetrical in shape with regard to the longitudinal axis, which allows the same piece to be used (3) on the upper and lower part of the window lifter rail.

The support device (3) holds the aforementioned stoppers (5) for the end of the cable cover. These stoppers (5) include a tubular body (6) manufactured in a plastic material which is attached to the flat cover (3). Inside this the end of the cover is held (not shown). The tubular body (6) is attached in the manner described below.

As can be seen in FIG. 1, the tubular body (6) has a lower extension (7) in the form of the clip. This may be inserted into the opening (11) of the flat cover (3) this clip configuration mainly prevents the tubular body (6) from being released from the support, (3) for the pulley (2) once it has been inserted into the aforementioned opening (11). Also, the tubular body (6) also has side tabs (8, 9) which are supported on the surface of the flat cover (3) in order to have a holding pressure once the aforementioned lower extension (7) has been inserted into the aforementioned opening (11). The side tabs (8, 9) add stability to the tubular body (6) on the cover (3).

In FIG. 3, the flat cover, which forms the support device (3) for the pulley (2), not shown in this drawing, may be seen. Also shown is the opening (10) for the rivet (4) for the pulley (2) to pass through as well as the circular opening (11th) for inserting the lower extension (7) of the tubular body (6). The circular shape of the opening (11) allows the tubular body (6) of the cable stopper to turn. Its final positioning is carried out using the holes (12) radially located on this plate (3) into one of which the pivot is located which extends from the aforementioned tubular body (6) (not shown). These holes (12) in combination with the aforementioned pivot comprise a way of positioning these stoppers at an angle (5).

In FIG. 3 and in FIG. 4, the formation of the positioning projection may be seen (13) which extends downwards to be inserted into one of the holes in the rail setting the position of the support device (3) for the pulley (2) on the rail; i.e the angle of departure for the window lifter cable and cover. The aforementioned projection (13) is formed by bending the end of the cover (3) at the opposite end to where the opening is located (11) as can be seen in FIGS. 3 and 4.

Having sufficiently described how the pulley device for vehicle window lifters is formed for this invention using the attached drawings, it is understood that any modification to the detail of the mention which is judged to be suitable may be made whenever the essential features of the summarised invention in the following claims are not altered.

1. A pulley device for vehicle window lifters which includes a revolving pulley and a support device onto which the pulley is mounted which is rigidly attached to an end of a window lifter rail and includes stoppers wherein the support device is a flat member equipped with an opening for assembling the stoppers at the end thereof and includes means for positioning at an angle the stoppers.

2. A pulley device for vehicle window lifters according to claim 1, wherein the stoppers include a tubular body attached to the flat member, the tubular body having a lower extension insertable into the opening on the flat member which has a substantially V-shaped cross-section to prevent the tubular body from being released from the flat member.

3. A pulley device for vehicle window lifters according to claim 2, wherein the means for positioning the stoppers at an angle includes a plurality of holes in the support device into one of which a pivot extending from the tubular body is inserted.

4. A pulley device for vehicle window lifters according to claim 2, wherein the tubular body has side tabs which are supported on the flat member once the lower extension has been inserted into the opening.

5. A pulley device for vehicle window lifters according to claim 1, wherein the support device has a positioning projection which extends downwards and is insertable into a hole in the rail to provide a departure angle preventing the support device from turning around an axis of the pulley.

6. A pulley device for vehicle window lifters according to claim 1, wherein the support device includes a central turret with a hole therethrough to attach the window lifter rail using the pulley.

7. A pulley device for window lifters in vehicle in accordance with claim 1, wherein the support device includes a central turret equipped with a hole to fix the window lifter rail using the pulley.
